(19) United States
(12) Patent Application Publication
(10) Pub. No.: US 2006/0020785 A1
(43) Pub. Date: Jan. 26, 2006

(54) Secure distribution of a video card public key

(76) Inventors: David W. Grawrock, Aloha, OR (US); Willard M. Wiseman, Vernonia, OR (US); James A. Sutton II, Portland, OR (US); Clifford D. Hall, Orangevale, CA (US); Ned M. Smith, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,264

(22) Filed: Jun. 30, 2004

(51) Int. Cl. H04L 9/00

(52) U.S. Cl. 713/164

(57) ABSTRACT

A system and method for secure distribution of a video card public key. The method provides for loading an authentication code module into a processor, authenticating the authentication code module, and executing the authentication code module. Executing the authentication module causes the authentication code module to assert a hardware indicator to access at least one address in a special protected page on a chipset. Receipt of the hardware indicator by the chipset causes a specific reference to be sent via a dedicated port to a circuit card to retrieve a public key from the circuit card.

### FIELD OF THE INVENTION

The present invention is generally related to security. More particularly, embodiments of the present invention are related to a system and method for secure distribution of a circuit card public key.

### DESCRIPTION

Often times the need arises to have the ability to access a circuit card, such as a video card, wherein the circuit card provides a key that can be retrieved and used to authenticate the circuit card and encrypt, or lead to the encryption of, subsequent transactions to the circuit card. A problem that exists with circuit cards that provide public/private key pairs on the circuit card is that the circuit card may be accessible by most or all software. The key pair represents a unique identifier that may be used to expose a unique identifier for a user's computer system. More often than not, users do not like others putting in unique identifiers that allow their computer systems to be uniquely identified without the user having given permission to do so. Also, the desired software needs to know that the public key that it is going to share a session key with is actually from a circuit card that is physically connected within the computer system, not a circuit card that is, for example, remote or via some other bus.

Thus, what is needed is a system and method for secure distribution of a circuit card public key to allow accessibility to desired software while preventing undesired software from accessing the key. What is also needed is a system and method that enables the transmission of the public key from the circuit card to the kernel without interference or spoofing, while also respecting the user's privacy. What is further needed is a system and method for enabling the desired software to know that the public key that it is going to share the session key with is from a circuit care that is within close proximity, or physically attached, to the computer system.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary computer system.

FIG. 2 is a block diagram illustrating an exemplary computer system for secure distribution of a circuit card public key according to an embodiment of the present invention.

FIG. 3 is a flow diagram illustrating an exemplary method for secure distribution of a circuit card public key according to an embodiment of the present invention.

FIG. 4 is a flow diagram illustrating an exemplary method for execution of an authenticated code (AC) module according to an embodiment of the present invention.

### DETAILED DESCRIPTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrases “in one embodiment” or “in an embodiment” appearing in various places throughout the specification are not necessarily all referring to the same embodiment.

Embodiments of the present invention are directed to a system and method for secure distribution of a circuit card public key. The public key of the circuit card is transmitted from the circuit card to a trusted kernel without interference or spoofing. The transmission of the public key to the kernel is also respective of the user's privacy. This is accomplished by (1) having the circuit card in close proximity, or physically attached, to a chipset, (2) ensuring that the circuit card only gives the public key to a trusted kernel, and (3) ensuring that the exposure of the public key, or unique identifying information, is enforced by encryption/decryption operations applied by a trusted platform module (TPM). TPMs conform to the Trusted Computing Platform Alliance or TCPA standard, Main Specification Version 1.1b, www.trustedcomputing.org/docs/main%20v11b.pdf (2002).

Embodiments of the present invention are described using a video circuit card. Although embodiments of the present invention are described using a video circuit card, one skilled in the relevant art(s), after reading the teachings described herein, will know that other types of circuit cards are also applicable. For example, a circuit card that plugs into a special port located on a chipset, an input/output control device, or a memory control device may also be used.

Embodiments of the invention use an authenticated code (AC) module that is closely tied to a trusted platform module (TPM). Levels of locality are defined as part of the TPM and are structured to define the type of software or agent that is making an access within the system. For example, a locality 4 may be a hardware process, such as, for example, a secure enter process (SEnter). SEnter is described below in more detail. A locality 3 may be helper software to load a monitor, such as, for example, an AC module. A locality 2 may be a monitor or trusted operating system. A locality 1 may be software under the control of a monitor. And a locality 0 may be software with no special meaning or legacy application.

Embodiments of the invention also place the video card into a reserved slot. The reserved slot is directly connected to a chipset via an Input/Output Controller Hub (ICH) or a memory controller hub (MCH). In one embodiment, the video card is connected to a special socket on the chipset. The chipset has a reserved special memory-mapped page associated with the special socket that requires hardware security level assertion to access the page. The special memory-mapped page provides the only access to a small range of addresses, referred to as the protected range, on a bus to the video card. This protected range provides a private channel to the video card to access a public key associated with the video card. By using this technique, a standard bus, such as an Accelerated Graphics Port (AGP) can be used without modification. The chipset also protects the protected range from peer-to-peer traffic from other devices. Accessing a specific address on the reserved page generates a special command to the video card, thereby causing the video card to return the public key. The information from the public key is then sent to the TPM to be sealed.

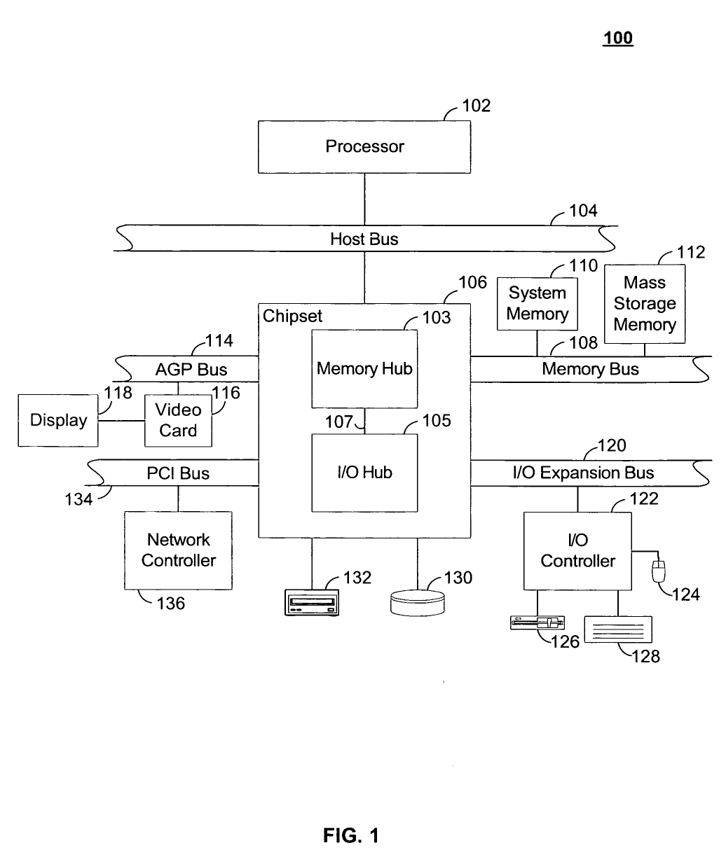

Embodiments of the present invention may be implemented using hardware, software, or a combination thereof and may be implemented in one or more computer systems or other processing systems. In fact, in one embodiment, the invention is directed toward one or more computer systems capable of carrying out the functionality described herein. An example implementation of a computer system 100 is shown in FIG. 1. Various embodiments are described in terms of this exemplary computer system 100. After reading this description, it will be apparent to a person skilled in the relevant art how to implement the invention using other computer systems and/or computer architectures.

Computer system 100 includes one or more processors, such as processor 102. Processor 102 may include a general-purpose or special-purpose processor such as a microprocessor, microcontroller, a programmable gate array (PGA), and the like. As used herein, the term “computer system” may refer to any type of processor-based system, such as, but not limited to, a desktop computer, a server computer, a laptop computer, an appliance, a set-top box, etc.

Processor 102 may be coupled over a host bus 104 to a chipset 106. Chipset 106 may include a memory controller hub (MCH) 103 coupled to an input/out (I/O) controller hub (ICH) 105 via a hub link 107. As is well known, a chipset typically provides I/O and memory management functions as well as a plurality of general purpose and/or special purpose functions that are accessible or used by one or more processors, such as processor 102. Chipset 106 may be coupled to a system memory 110 and a mass storage memory 112 via a memory bus 108. System memory 110 may include any type of volatile and/or non-volatile memory, such as, but not limited to, static random access memory (SRAM), dynamic random access memory (DRAM), flash memory, read-only memory (ROM), etc. Mass storage memory may include any type of mass storage device, such as, but not limited to, hard disk drives, optical disk drives, magnetic tape drives, etc.

Chipset 106 may also be coupled to a video card 116 over an Advanced Graphics Port (AGP) bus 114. The AGP bus 114 may conform to the Accelerated Graphics Port Interface Specification, Revision 2.0, published May 4, 1998, by Intel Corporation, Santa Clara, Calif. Video card 116 may be coupled to a display 118.

Chipset 106 may also be coupled to an I/O expansion bus 120 and a Peripheral Component Interconnect (PCI) bus 134, as defined by the PCI Local Bus specification, Production Version, Revision 2.1 dated June 1995. I/O expansion bus 120 may be coupled to an I/O controller 122 that controls access to one or more I/O devices. As shown in FIG. 1, I/O devices may include, but are not limited to, storage devices such as a floppy disk drive 126 and input devices such as a keyboard 128 and a mouse 124. Chipset 106 may also be coupled to, for example, a hard disk drive 130 and a compact disc (CD) drive 132, as shown in FIG. 1. Storage devices, such as floppy disk drive 126 and compact disc drive 132 may be removable storage drives. Removable storage drives read from and/or write to removable storage units in a well-known manner. Removable storage units represent floppy disks, compact discs, etc., which are read by and written to by the removable storage drives. As will be appreciated, removable storage units include computer usable storage mediums having stored therein computer software and/or data. One skilled in the relevant art(s) would know that other storage devices may also be included in the system.

PCI bus 134 may be coupled to various components including, for example, a network controller 136. Network controller 136 may be coupled to a network port (not shown) to allow software and data to be transferred between computer system 100.

In this document, the term “computer program product” refers to removable storage units, such as, but not limited to, floppy disks and compact disks. These computer program products are means for providing software to computer system 100. Embodiments of the invention are directed to such computer program products.

Computer programs (also called computer control logic) are stored in system memory 110, mass storage memory 112, and/or in computer program products. Computer programs may also be received via a network port (not shown) attached to network controller 136. Such computer programs, when executed, enable computer system 100 to perform the features of embodiments of the present invention as discussed herein. In particular, the computer programs, when executed, enable processor 102 to perform the features of embodiments of the present invention. Accordingly, such computer programs represent controllers of computer system 100.

In an embodiment where the invention is implemented using software, the software may be stored in a computer program product and loaded into computer system 100 using removable storage drives 126 and 132, hard disk drive 130, or a network port via network controller 136. The control logic (software), when executed by processor 102, causes processor 102 to perform the functions of embodiments of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

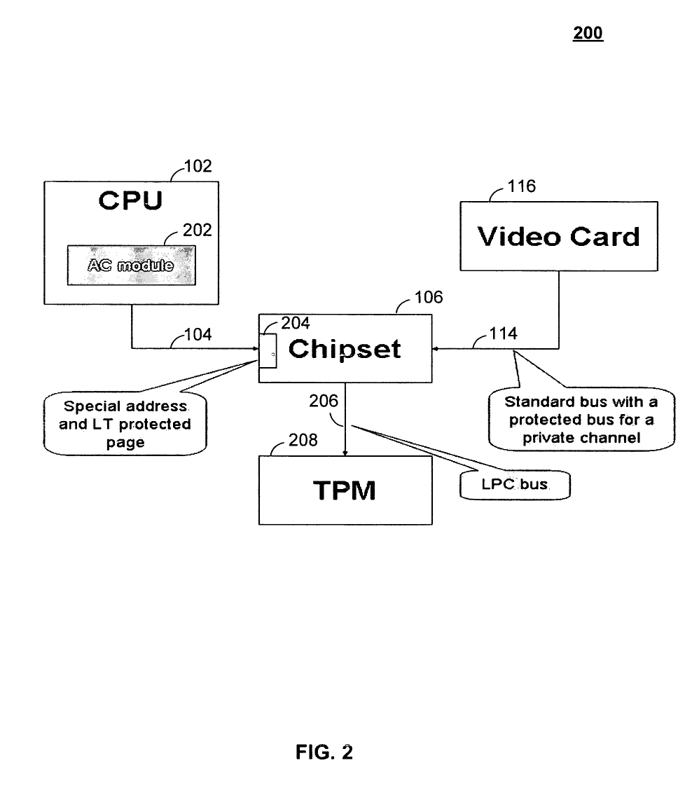

FIG. 2 is a block diagram illustrating an exemplary system 200 for secure distribution of a video card public key according to an embodiment of the present invention. System 200 comprises, inter alia, processor 102, chipset 106, video card 116, and a trusted platform module (TPM) 208 coupled to chipset 106 via a Low Pin Count (LPC) bus 206.

TPM 208 is specifically designed to enhance platform security. TPM 208 provides hardware-based protection for the encryption and digital signature keys that secure the confidentiality of user data. TPM 208 protects encryption keys and platform authentication information from software-based attacks by securing them in hardware.

Processor 102 is shown with an Authentication Code (AC) module 202. In one embodiment, AC module 202 is stored in memory and an explicit instruction, is used to bring AC module 202 into processor 102, authenticate it, and execute it. AC module 202 provides assurances that no other software is running on processor 102. AC module 202 also provides assurance of the proximity of video card 116 and that the public key from video card 116 is handled by TPM 208.

The assurance that no other software is running on processor 102 is inherent in the design of AC module 202. AC module 202 allows a user of system 200 to know that other software is not spoofing a request to obtain the public key from video card 116 or performing as a man-in-the-middle. Although it is possible for code to be running on any PCI device, the assurance that AC module 202 is directly communicating with video card 116 mitigates that attack.

AC module 202 provides assurance of the proximity (i.e., location) of video card 116 by accessing a return-public-key function for video card 116 through a special address reserved in chipset 106. The reserved address, which resides within a protected page 204 of chipset 106, is only available to AC module code, and chipset 106 may only forward this access directly to the reserved video card slot. Thus, enabling the proximity of video card 116 and AC module 202 to be verified.

AC module 202 ensures that TPM 208 handles the public key by sending the public key to TPM 208 to be sealed and then to be utilized by the trusted kernel. Sealing may be launched using the SEnter process. An SEnter instruction triggers a series of operations that result in a secure launch of a piece of software referred to as a kernel. The sealing operation can only occur if the TPM owner has explicitly authorized use of TPM 208. This authorization indirectly includes authorization to access the video card public key. If the TPM owner has not authorized use of TPM 208, then AC module 202 cannot seal the public key for use by the trusted kernel and the public key is not exposed to any other software. In one embodiment, for a stronger owner-authorization assurance, AC module 202 may use symmetric encryption on the public key and then store the session key in a non-volatile storage area of TPM 208, thereby requiring TPM owner authorization to read the value. In one embodiment, the non-volatile storage area may require an attribute of locality 3 to write.

In embodiments of the present invention, AC modules provide a hardware (HW) indication to a chipset that the AC modules are running. In one embodiment, the processor uses locality 3 to indicate that an AC module is running. AC module 202, once loaded into processor 102, may be authenticated against a signature. The signature indicates that AC module 202 came from a chipset vendor and that the chipset vendor stands behind AC module 202. Once AC module 202 has been loaded into processor 102 and authenticated, AC module 202 may be invoked. Once invoked, AC module 202 may run securely inside processor 102 without anything tampering with its execution. AC module 202 communicates with chipset 106 using a HW indication to chipset 106 to indicate that AC module 202 is running.

Chipset 106 includes a reserved memory-mapped address page 204 representing access to special functions of video card 116, including a read-public-key function. Chipset 106 may recognize or provide access to particular registers, buses, or memory mapped addresses based on the locality of the reference. Access to this reserved page requires a hardware (HW) indication that AC module 202 is running. In the reserved memory-mapped address range, chipset 106 will convert the HW indication that AC module 202 is running to special commands and send the special commands to video card 116 to retrieve the public key that represents the unique identifying information. Since video card 116 is designed to only release the public key using the HW indication that AC module 202 is running from chipset 106, this provides the assurance that the only software that can access the public key is software running in AC module 202. This restriction prevents any regular software from generating the command to expose the public key on video card 116. The reserved memory-mapped page provides the only access to a small range of addresses (i.e., a protected range) on the bus to video card 116. The protected range provides a private channel to video card 116 to access the public key. Accessing a specific address on the reserved page generates a special command to video card 116, causing video card 116 to return the public key.

Chipset 106 does not forward or otherwise generate the special function requests for video card 116 unless access was initiated through the reserved page. This restriction prevents other (non-processor) devices from generating similar access requests to video card 116, thus preventing the exposure of the public key of video card 116 to other devices.

Video card 116 is coupled directly to chipset 106. The direct connection is vital to assuring video card 116 that no software on processor 102 or on any PCI bus between chipset 106 and video card 116 can spoof a request for the public key from AC module 202. As previously indicated, when AC module 202 sends a command directly to chipset 106 in the reserved memory-mapped address range, a special command is generated and sent to video card 116, thereby causing video card 116 to return the public key. Again, video card 116 will only release the public key in response to the special command generated from chipset 106 in response to the HW indication to chipset 106 that AC module 202 is running. Commands to chipset 106 from AC module 202 are in the protected range.

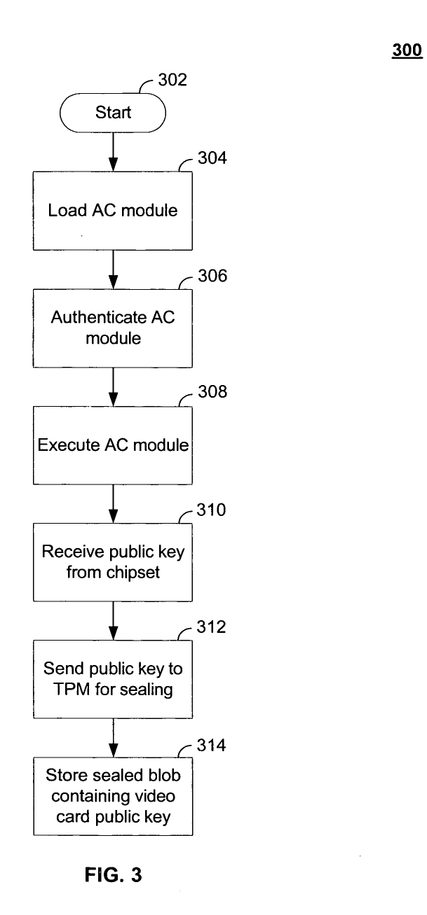

FIG. 3 is a flow diagram 300 illustrating an exemplary method for secure distribution of a circuit card public key according to an embodiment of the present invention. The invention is not limited to the embodiment described herein with respect to flow diagram 300. Rather, it will be apparent to persons skilled in the relevant art(s) after reading the teachings provided herein that other functional flow diagrams are within the scope of the invention. The process begins with block 302, where the process immediately proceeds to block 304.

In block 304, AC module 202 is loaded into processor 102. In one embodiment, AC module 202 is stored in system memory 110. In this embodiment, AC module 202 is taken from system memory 110 and loaded into processor 102. In another embodiment, AC module 202 may be stored in mass storage memory 112 and loaded into processor 102. In yet other embodiments of the invention, AC module 202 may be retrieved from removable storage units, such as, but not limited to, floppy disks and compact discs, that are read by removable storage drives, such as, but not limited to, floppy disk drive 126 and compact disc drive 132, and loaded into processor 102.

In block 306, AC module 202 is authenticated. The authentication is based on the fact that AC module 202 is signed by the chipset vendor. AC module 202 is authenticated using a key associated with chipset 106.

In block 308, AC module 202 is executed.

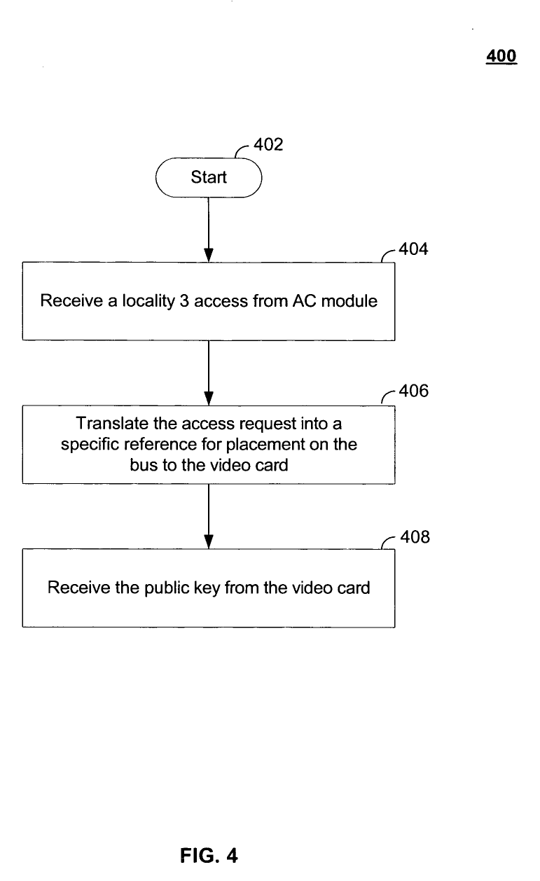

FIG. 4 is a flow diagram 400 illustrating an exemplary method for AC module execution according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, AC module 202 asserts a HW indication over bus 104 from processor 102 to at least one address in the reserved memory-mapped address page 204 of chipset 106 to indicate that AC module 202 is running. When chipset 106 receives the HW indication for reserved page 204, indicating that AC module 202 is running, access to video card 116 will be permitted.

The protected page access causes chipset 106 to generate a special command to video card 116. In block 406, chipset 106 will translate the access request into the special command and place the special command on AGP bus 114 to be sent to video card 116. The special command is only permitted to be sent over the particular port designated for video card 116. The special command represents at video card 116 a request to return its public key. This is the only way that access to the public key may be obtained from video card 116.

In response to the special command, video card 116 will return the public key over AGP bus 114 to chipset 116 (block 408).

Returning to FIG. 3, in block 310, AC module 202 receives the public key from chipset 106. Chipset 106 sends the public key over host bus 104 to AC module 202 via processor 102.

AC module 202 needs to save the public key in a way that it can be retrieved by securely launched kernels that are designated as proper recipients for the public key. In block 312, AC module 202 sends the public key to TPM 208 along with a request to seal the public key to the kernel using TPM 208. Sealing enables TPM 208 to encrypt the public key along with other platform configuration information such that when a device tries to unseal it or decrypt it, the other platform configuration information is checked to make sure it is a match. Sealing is performed when the platform configuration reflects that the correct kernel has been launched. Sealing the public key to the kernel results in a sealed blob containing the video card public key. The sealed blob can only be unsealed by TPM 208 for use by the trusted kernel.

In block 314, AC module 202 receives the sealed blob from TPM 208 for storing. The sealed blob, also referred to as an encryption blob in some embodiments, may be stored in any storage device. In one embodiment, the sealed blob may be stored in system memory 110. In another embodiment, the sealed blob may be stored in mass storage device 112. In yet another embodiment, the sealed blob may be stored on a removable storage unit using a removable storage disk. The sealed blob may only be decrypted by the TPM that encrypted it.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A secure access method comprising:
loading an authentication code module into a processor;
authenticating the authentication code module; and
executing the authentication code module, wherein executing the authentication module causes the authentication code module to assert a hardware (HW) indication to provide access to at least one address in a special protected page on a chipset, wherein receipt of the hardware indication by the chipset causes a specific reference to be sent via a dedicated port to a circuit card to retrieve a public key from the circuit card.

2. The method of claim 1, further comprising:
sending the public key to a trusted platform module to be sealed; and
storing the information from the sealed public key to enable retrieval by securely launched kernels that are designated as proper recipients for the public key.

3. The method of claim 1, wherein the circuit card is a video card.

4. The method of claim 1, wherein the authentication code module uses symmetric encryption on the public key and stores a session key in a TPM non-volatile storage area, wherein TPM owner authorization is required to read the session key.

5. A secure access method comprising:
accessing a public key on a circuit card, the circuit card being connected to a special socket on a chipset, wherein accessing the public key includes using an authenticated code module to provide a hardware indication for access to the chipset, the chipset including a reserved special memory-mapped page that requires the HW indication for access, wherein the special memory-mapped page provides access to a small range of addresses on a bus to the circuit card, the small range of addresses providing a private channel to the circuit card to access the public key; and
sealing the public key to a kernel.

6. The method of claim 5, wherein sealing the public key to a kernel comprises sealing the public key to a kernel using a trusted platform module (TPM), wherein exposure to the public key is enforced by encryption/decryption techniques applied by the TPM.

7. The method of claim 5, wherein the circuit card comprises a video card and the bus to the video card comprises an Advanced Graphics Port (AGP) bus.

8. The method of claim 5, further comprising storing the sealed public key to enable retrieval by securely launched kernels that are designated as proper recipients for the public key.

9. The method of claim 5, wherein accessing the public key includes accessing a specific address in the small range of addresses.

10. The method of claim 9, wherein accessing the specific address generates a special command to the circuit card that, in turn, causes the circuit card to return the public key.

11. An article comprising: a storage medium having a plurality of machine accessible instructions, wherein when the instructions are executed by a processor, the instructions provide for loading an authentication code module into a processor;
authenticating the authentication code module; and
executing the authentication code module, wherein executing the authentication module causes the authentication code module to assert a hardware (HW) indication to provide access to at least one address in a special protected page on a chipset, wherein receipt of the hardware indication by the chipset causes a specific reference to be sent via a dedicated port to a circuit card to retrieve a public key from the circuit card.

12. The article of claim 11, further comprising instructions for:
sending the public key to a trusted platform module to be sealed; and
storing the information from the sealed public key to enable retrieval by securely launched kernels that are designated as proper recipients for the public key.

13. The article of claim 11, wherein the circuit card is a video card.

14. The article of claim 11, wherein the authentication code module uses symmetric encryption on the public key and stores a session key in a TPM non-volatile storage area, wherein TPM owner authorization is required to read the session key.

15. An article comprising: a storage medium having a plurality of machine accessible instructions, wherein when the instructions are executed by a processor, the instructions provide for accessing a public key on a circuit card, the circuit card being connected to a special socket on a chipset, wherein accessing the public key includes using an authenticated code module to provide a hardware indication for access to the chipset, the chipset including a reserved special memory-mapped page that requires the HW indication for access, wherein the special memory-mapped page provides access to a small range of addresses on a bus to the circuit card, the small range of addresses providing a private channel to the circuit card to access the public key; and
sealing the public key to a kernel.

16. The article of claim 15, wherein instructions for sealing the public key to a kernel comprises instructions for sealing the public key to a kernel using a trusted platform module (TPM), wherein exposure to the public key is enforced by encryption/decryption techniques applied by the TPM.

17. The article of claim 15, wherein the circuit card comprises a video card and the bus to the video card comprises an Advanced Graphics Port (AGP) bus.

18. The article of claim 15, further comprising instructions for storing the sealed public key to enable retrieval by securely launched kernels that are designated as proper recipients for the public key.

19. The article of claim 15, wherein instructions for accessing the public key includes instructions for accessing a specific address in the small range of addresses.

20. The article of claim 19, wherein instructions for accessing the specific address generates a special command to the circuit card that, in turn, causes the circuit card to return the public key.

21. A system for secure access comprising:
a processor having an authenticated code module loaded into the processor;
a chipset coupled to the processor, the chipset having a reserved memory-mapped page requiring a hardware indication from the authenticated code module to enable access of the reserved memory-mapped page, the reserved memory-mapped page to provide the only access to a small range of addresses;
a circuit card coupled to a reserved slot connected to the chipset, wherein the small range of addresses to provide a private channel to the circuit card to access a public key; and
a trusted platform module to seal the public key.

22. The system of claim 21, wherein the circuit card comprises a video card.

23. The system of claim 21, wherein the authenticated code module uses a return-public-key function of the circuit card to access the public key via the small range of addresses that provide the private channel to the circuit card.

24. The system of claim 21, wherein the hardware indication from the authentication code module indicates that the authentication code module is running.
